(19) United States
(12) Patent Application Publication
(10) Pub. No.: US 2017/0177062 A1
(43) Pub. Date: Jun. 22, 2017

(54) SEMICONDUCTOR DEVICE, SEMICONDUCTOR SYSTEM, AND CONTROL METHOD OF SEMICONDUCTOR DEVICE

(71) Applicant: Renesas Electronics Corporation, Tokyo (JP)

(72) Inventor: Hiroshi UEKI, Tokyo (JP)

(73) Assignee: Renesas Electronics Corporation, Tokyo (JP)

(21) Appl. No.: 15/375,562

(22) Filed: Dec. 12, 2016

(30) Foreign Application Priority Data
Dec. 18, 2015 (JP) 2015-247581

(51) Int. Cl. G06F 1/32

(52) U.S. Cl. CPC G06F 1/3228; G06F 1/3278; G06F 1/329

(57) ABSTRACT

According to one embodiment, a semiconductor device includes an operation circuit 20 that calculates an expected value μ′ of a new waiting time based on a measured value z of a waiting time of an apparatus to be controlled 15 that varies depending on a timing when an interruption signal is generated and an expected value μ of the waiting time, and a waiting mode control circuit 12 that sets a waiting state when the apparatus to be controlled 15 is waiting to a waiting state in accordance with the expected value μ′ of the new waiting time.

### CROSS-REFERENCE TO RELATED APPLICATIONS

This application is based upon and claims the benefit of priority from Japanese patent application No. 2015-247581, filed on Dec. 18, 2015, the disclosure of which is incorporated herein in its entirety by reference.

### BACKGROUND

The present invention relates to a semiconductor device, a semiconductor system, and a control method of the semiconductor device and relates to, for example, a semiconductor device, a semiconductor system, and a control method of the semiconductor device capable of efficiently reducing power consumption.

In recent years, a microcomputer and the like changes its mode from a normal operation mode to a waiting mode (standby mode) when it is not executing a program to limit supply of a clock signal or a power supply voltage, whereby an increase in power consumption is suppressed.

Japanese Patent. No. 566729, for example, discloses a method of operating an apparatus that has a first standby mode and a second standby mode in which a startup time is shorter and power consumption is larger than those in the first standby mode.

### SUMMARY

According to the method disclosed in Japanese Patent No. 5667294, when the waiting time at the time of waiting is not determined in advance as in the case in which the waiting mode is released by an interruption signal input from an outside, it is difficult to appropriately select the waiting mode in which the total energy consumption is minimized. Therefore, according to the method disclosed in Japanese Patent No. 5667294, it is difficult to efficiently reduce the power consumption. The other problems of the related art and the novel characteristics of the present invention will be made apparent from the descriptions of the specification and the accompanying drawings.

According to one embodiment, a semiconductor device includes: an operation unit that calculates an expected value of a new waiting time based on a measured value of a waiting time of an apparatus to be controlled that varies depending on a timing when an interruption signal is generated and an expected value of the waiting and a waiting mode control circuit that sets a waiting state when the apparatus to be controlled is waiting to a waiting state in accordance with the expected value of the new waiting time.

Further, according to one embodiment, a control method of a semiconductor device includes: measuring a waiting time of an apparatus to be controlled that varies depending on a timing when an interruption signal is generated; calculating an expected value of a new waiting time based on a measured value of the waiting time and an expected value of the waiting time; and setting a waiting state when the apparatus to be controlled is waiting to a waiting state in accordance with the expected value of the new waiting time.

According to the embodiment, it is possible to provide a semiconductor device, semiconductor system, and a control method of the semiconductor device capable of efficiently reducing power consumption even when a waiting time varies depending on a timing when an external interruption signal generated.

### BRIEF DESCRIPTION OF THE DRAWINGS

The above and other aspects, advantages and features will be more apparent from the following description of certain embodiments taken in conjunction with the accompanying drawings, in which:

FIG. 1 is a block diagram showing a configuration example of a semiconductor system according to a first embodiment;

FIG. 2 is a diagram showing a transition from a prior distribution to a posterior distribution of a probability when gamma distribution Bayesian statistics are used;

FIG. 3 is a flowchart showing an operation of setting a waiting mode in the semiconductor system shown in FIG. 1;

FIG. 4 is a block diagram showing a modified example of the semiconductor system shown in FIG. 1;

FIG. 5 is a block diagram showing a configuration example of a semiconductor system according to a second embodiment;

FIG. 6 is a flowchart showing an operation of setting a waiting mode in the semiconductor system shown in FIG. 5;

FIG. 7 is a block diagram showing a configuration example of a semiconductor system according to the idea before an embodiment has been devised;

FIG. 8 is a diagram showing a relation among a type of the waiting mode, energy that is required for a mode transition, and power consumption in the waiting mode; and

FIG. 9 is a diagram showing a relation between the waiting time and the total energy consumption for each type of the waiting mode.

### DETAILED DESCRIPTION

Embodiments of the present invention will be described below with reference to the accompanying drawings. Note that the drawings are in simplified form, and the technical scope of the embodiments should not be interpreted to be limited to the drawings. The same elements are denoted) the same reference numerals, and a duplicate description is omitted.

In the following embodiments, when necessary, the present invention is explained by using separate sections or separate embodiments. However, those embodiments are not unrelated with each other, unless otherwise specified. That is, they are related in such a manner that one embodiment is a modified example, an application example, a detailed example, or a supplementary example of a part or the whole of another embodiment. Further, in the following embodiments, when the number of elements or the like (including numbers, values, quantities, ranges, and the like) is mentioned, the number is not limited to that specific number except for cases where the number is explicitly specified or the number is obviously limited to a specific number based on its principle. That is, a larger number or a smaller number than the specific number may also be used.

Further, in the following embodiments, the components (including operation steps and the Like) are not necessarily indispensable except for cases where the component is explicitly specified or the component is obviously indispensable based on its principle. Similarly, in the following embodiments, when a shape, a position relation, or the like of a component(s) or the like is mentioned, shapes or the like that are substantially similar to or resemble that shape are also included in that shape except for cases where it is explicitly specified or they are eliminated based on its principle. This is also true for the above-described number or the like (including numbers, values, quantities, ranges, and the like).

### <Previous Studies By the Inventors>

Before describing the details of a semiconductor system according to a first embodiment, a semiconductor system 50 that has been previously studied by the present inventors will be described first.

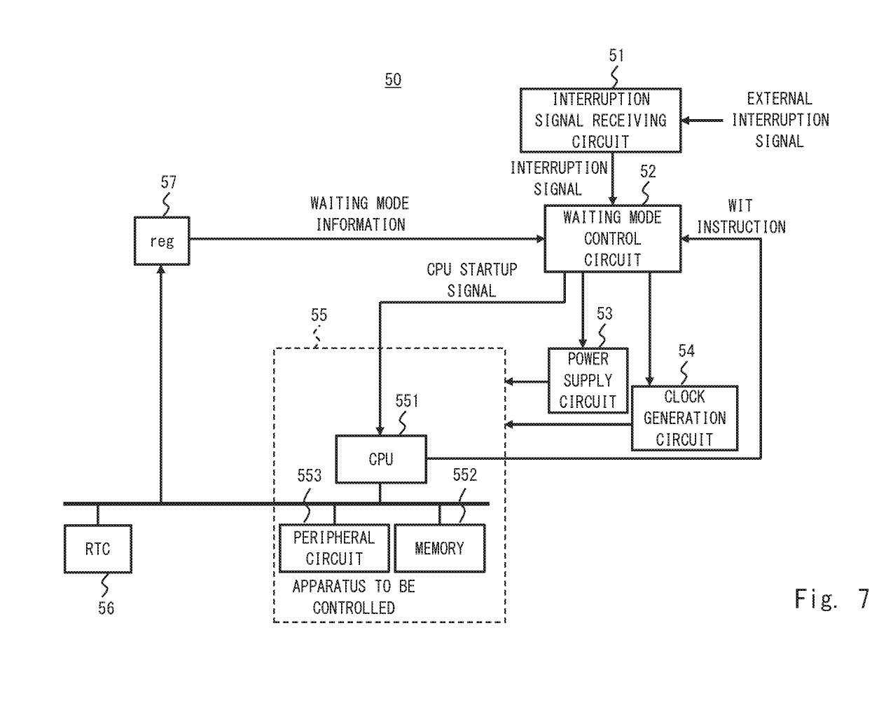

FIG. 7 is a block diagram showing a configuration example the semiconductor system 50 according to the idea before the embodiment has been devised. The semiconductor system 50 is, for example, a microcomputer and controls a waiting state when an apparatus to be controlled 55 is waiting (that is, a type of a waiting mode).

As shown in FIG. 7, the semiconductor system 50 includes an interruption signal receiving circuit 51, a waiting mode control circuit 52, a power supply circuit 53, a clock generation circuit 54, an apparatus to be controlled 55, a Real Time Clock tuner (RTC) 56, and a register 57. The apparatus to be controlled 55 includes a CPU 551, a memory 552, and a peripheral circuit 553. Among the components of the semiconductor system 50, the components other than the apparatus to be controlled 55 compose a control apparatus to control the type of the waiting mode of the apparatus to be controlled 55.

The apparatus to be controlled 55 is composed of, for example, a Central Processing Unit (CPU) 551, a memory 552, and a peripheral circuit 553. The apparatus to be controlled 55 is driven by a power supply voltage supplied from the power supply circuit 53 and operates in synchronization with a clock signal generated by the clock generation circuit 54.

The CPU 551 executes, for example, operation processing in accordance with a program stored in the memory 552. The memory 552 stores the program, operation results of the CPU 551 and the like. The peripheral circuit 553 executes a predetermined processing in accordance with an instruction from the CPU 551.

The CPU 551 selects, before execution of a predetermined program is completed in a normal operation mode, the type of the waiting mode of the apparatus to be controlled 55. In this example, the CPU 551 determines one of a shallow standby mode, a deep standby mode, and a power off mode as the waiting mode. The information on the waiting mode is stored in the register 57.

In the shallow standby mode, for example, the clock signal is not supplied to the apparatus to be controlled 55 and the power supply voltage having a normal driving capability is supplied to the apparatus to be controlled 55. In the deep standby mode, the clock signal is not supplied to the apparatus to be controlled 55 and only the power supply voltage having a driving capability lower than normal is supplied to the apparatus to be controlled 55. In the power off mode, neither the clock signal nor the power supply voltage is supplied to the apparatus to be controlled 55.

When the execution of the predetermined program is completed in the normal operation mode, the CPU 551 issues a waiting instruction (WIT instruction) so that the mode is changed from the normal operation mode to the waiting mode.

Upon receiving the WIT instruction issued by the CPU 551, the waiting mode control circuit 52 changes the mode of the apparatus to be controlled 55 from the normal operation mode to the waiting mode specified by the waiting mode information stored in the register 57.

When the waiting mode information stored in the register 57 indicates the shallow standby mode, for example, the waiting mode control circuit 52 changes, after receiving the WIT instruction, the mode of the apparatus to be controlled 55 from the normal operation mode to the shallow standby mode. Specifically, the waiting mode control circuit 52 stops supply of the clock signal to the apparatus to be controlled 55 and keeps supply of the power supply voltage having the normal driving capability.

On the other hand, when the waiting mode information stored in the register 57 indicates the deep standby mode, for example, the waiting mode control circuit 52 changes, after receiving the WIT instruction, the mode of the apparatus to be controlled 55 from the normal operation mode to the deep standby mode. Specifically, the waiting mode control circuit 52 stops supply of the clock signal to the apparatus to be controlled 55 and supplies the power supply voltage having a driving capability lower than normal.

Further, when the waiting mode information stored in the register 57 indicates the power off mode, for example, the waiting mode control circuit 52 changes, after receiving the WIT instruction, the mode of the apparatus to be controlled 55 from the normal operation mode to the power off mode. Specifically, the waiting mode control circuit 52 stops supply of the clock signal to the apparatus to be controlled 55 and stops supply of the power supply voltage.

After that, when an interruption signal (external interruption signal) is input from an outside of the semiconductor system 50, the interruption signal receiving circuit 51 transmits this interruption signal to the waiting de control circuit 52.

Upon receiving the interruption signal, the waiting mode control circuit 52 changes the mode of the apparatus to be controlled 55 from the waiting mode to the normal operation mode. Specifically, the waiting mode control circuit 52 causes the power supply circuit 53 to start supplying the power supply voltage and causes the clock generation circuit 54 to start supplying the clock signal. Further, the waiting mode control circuit 52 outputs a CPU startup signal to the CPU 551. The CPU 551 is thus able to return to a normal instruction processing operation.

After that, when execution of another program is (completed in the normal operation mode the CPU 551 issues the WIT instruction to change the mode from the normal operation mode to the waiting mode. Accordingly, the waiting mode control circuit 52 changes the mode of the apparatus to be controlled 55 from the normal operation mode to the waiting mode that has been specified by the waiting mode Information stored in the register 57. Then the waiting mode is kept until the time when the external interruption signal is input. In the semiconductor system 50, such an operation is repeated.

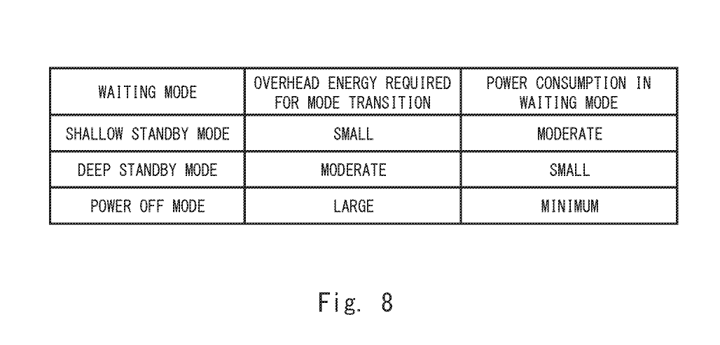

FIG. 8 is a diagram showing a relation among the type of the waiting mode, the energy required for the mode transition, and the power consumption in the waiting mode.

As shown in FIG. 8, when the type of the waiting mode is the shallow standby mode, it is sufficient that the supply of the clock signal s stopped in order to change the mode from the normal operation mode to the waiting mode. Therefore, the energy required for the mode transition is small. On the other hand, the power consumption in the waiting mode is relatively large (moderate).

Further, when the type of the waiting mode is the deep standby mode, in order to change the mode from the normal operation mode to the waiting mode, it is required not only to stop the supply of the clock signal but also to reduce the driving capability of the power supply voltage. Accordingly, the energy required for the mode transition becomes larger (moderate) than that in the shallow standby mode. On the other hand, the power consumption in the waiting more becomes smaller than that in the shallow standby mode.

Further, when the type of the waiting mode the power off mode, in order to change the mode from the normal operation mode to the waiting mode, both the supply of the clock signal and the supply of the power supply voltage need to be stopped. Accordingly, the energy required for the mode transition becomes larger than that in the deep standby mode. On the other hand, the power consumption in the waiting mode becomes smaller than that in the deep standby mode.

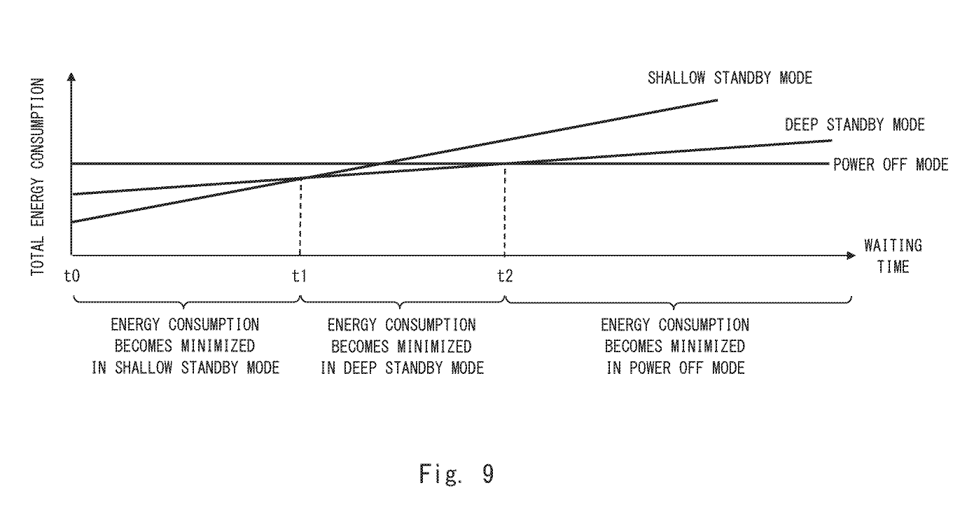

FIG. 9 is a diagram showing a relation between the waiting time and the total energy consumption for each type of the waiting mode. The total energy consumption is an energy obtained by adding the energy consumed when the modes are changed to the energy consumed in the waiting mode.

Referring to FIG. 9, when the waiting time is short (e.g., from time t0 (inclusive) to time t1 (exclusive)), the total energy consumption is minimized when the shallow standby mode is selected. When the waiting time is moderate (e.g., from time t1 (inclusive) to time t2 (exclusive)), the total energy consumption is minimized when the deep standby mode is selected. When the waiting time is long (e.g., time t2 or longer), the total energy consumption is minimized when the power off mode is selected.

Therefore, when the waiting time is predetermined, the waiting mode in which the total energy consumption is minimized in the waiting time may be selected. The measurement of the waiting time at this time is performed by the RTC 56 and the register 57 that keep counting regardless of the operation mode.

However, when the waiting time at the time of waiting is not determined in advance as in a case in which the waiting mode is released by an interruption signal that is input from an outside on an event-driven basis, it is difficult to appropriately select the waiting mode in which the total energy consumption is minimized. Therefore, in the semiconductor system 50, it is difficult to efficiently reduce the power consumption.

Even when the register 57 stores the waiting mode information indicating the shallow standby mode, for example, if the timing when the external interruption signal is generated is delayed and thus the waiting time becomes longer than expected, the mode may be preferably set to the deep standby mode or the power off mode rather than the shallow standby mode with regard to obtaining efficient reduction of the total energy consumption.

In order to solve the aforementioned problem, a semiconductor system 1 according to a first embodiment has been invented so that it becomes possible to efficiently reduce the power consumption even when the waiting time varies depending on the timing when the external interruption signal is generated.

### First Embodiment

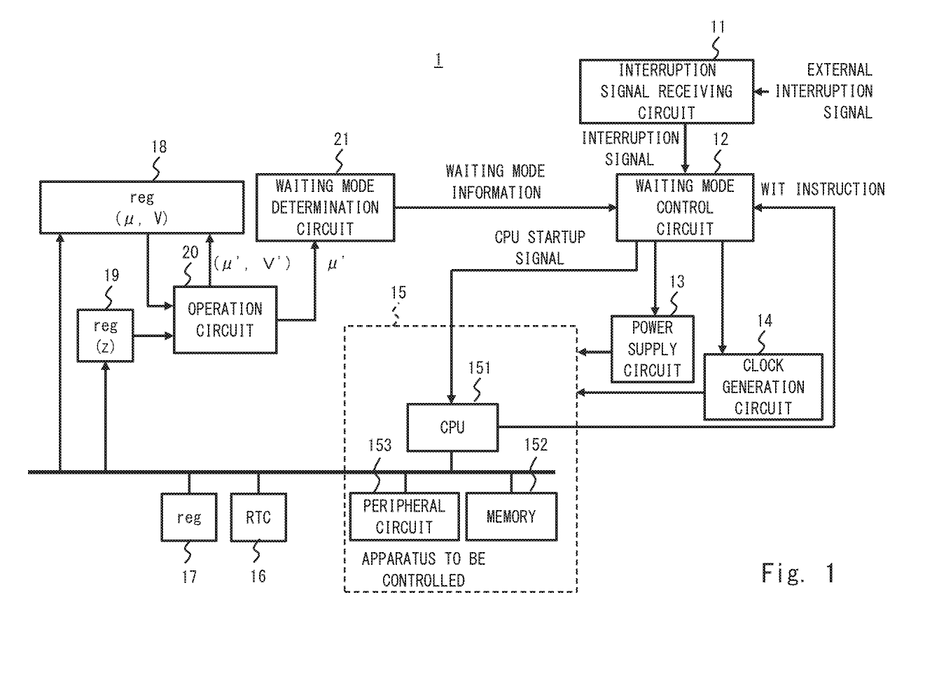

FIG. 1 is block diagram showing a semiconductor system 1 according to a first embodiment. The semiconductor system 1 according to this embodiment is, for example, a microcomputer, and controls a waiting state when an apparatus to be controlled is waiting (that is, type of a waiting mode).

The semiconductor system 1 calculates a new expected value μ′ based on a measured value z of a waiting time of the apparatus to be controlled that varies depending on the timing when an interruption signal is generated and an expected value μ and sets the waiting state when the apparatus to be controlled is waiting to a waiting state in accordance with the expected value μ′. Accordingly, the semiconductor system 1 is able to predict the waiting time and control the apparatus to be controlled to an optimal waiting state even when the waiting time of the apparatus to be controlled varies depending on the timing when the interruption Signal is generated, whereby it is possible to efficiently reduce the power consumption. In the following description, this point will be described in detail.

As shown in FIG. 1, the semiconductor system 1 includes an interruption signal receiving circuit 11, a waiting mode control circuit 12, a power supply circuit 13, a clock generation circuit 14, an apparatus to be controlled 15, an RTC 16, a register 17, a prior distribution value storage unit 18, a measured value storage unit 19, an operation circuit 20, and a waiting mode determination circuit 21. Among the components of the semiconductor system the components other than the apparatus to be controlled 15 compose a control apparatus (semiconductor device) to control the waiting state when the apparatus to be controlled 15 is waiting (that is, a type of the waiting mode).

The apparatus to be controlled 15 is composed of, for example a CPU 151, a memory 152, and a peripheral circuit 153. The apparatus to be controlled 15 driven by a power supply voltage supplied from the power supply circuit 13 and operates in synchronization with a clock signal generated by the clock generation circuit 14.

The CPU 151 executes operation processing in accordance with, for example, a program stored in the memory 152. The memory 152 stores the aforementioned program, operation results of the CPU 151 and the like. The peripheral circuit 153 executes predetermined processing in accordance with an instruction from the CPU 151.

When the apparatus to be controlled 15 does not execute a predetermined program, the apparatus to be controlled 15 changes its mode from a normal operation mode to the waiting mode, where the supply of the clock signal and the supply of the power supply voltage are limited. An increase in the power consumption is thus suppressed. The details of the waiting mode will be described later.

The prior distribution value storage unit 18 stores the expected value μ and a variance V of the waiting time of the apparatus to be controlled 15. In an initial state, the prior distribution value storage unit 18 stores a predetermined value determined based on past measurement results or the like.

The measured value storage unit 19 stores the measured value z or the waiting time of the apparatus to controlled 15. The waiting time (length of the waiting mode) of the apparatus to be controlled 15 is measured, for example, using the RTC 16 and the register 17.

The RTC 16 is a circuit that keeps counting regardless the operation mode of the apparatus to be controlled 15. The register 17 stores the count value of the RTC 16. The register 17 stores, for example, the count value of the RTC 16 when the mode of the apparatus to be controlled 15 is changed from the normal operation mode to the waiting mode. More specifically, the register 17 stores the count value of the RTC 16 when the waiting instruction (WIT instruction) is issued from the CPU 151. The waiting time of the apparatus to be controlled 15 is measured from the difference between the count value of the RTC 16 when the mode of the apparatus to be controlled 15 is changed from the waiting mode to the normal operation mode and the count value of the RTC 16 stored in the register 17.

The operation circuit (operation unit) 20 calculates, based on the measured value z of the waiting time and the expected value μ and the variance V of the waiting time, the expected value μ′ and a variance V′ of the new waiting time. The operation circuit. 20 calculates the expected value μ′ and the variance V′ of the new waiting time by, for example, substituting the measured value z of the waiting time and the expected value μ and the variance V of the waiting time into an expression of gamma distribution Bayesian statistics. In the initial state, the operation circuit 20 directly outputs the expected value μ and the variance V as the expected value μ′ and the variance V′.

Specifically, the relation among the expected value μ and the variance V of the prior distribution, the measured value z of the waiting time, and the expected value μ′ and the variance V′ of the posterior distribution is expressed as shown in the following Expressions (1) and (2).

$$\begin{matrix}{μ}^{′} = \frac{( {μ}^{2} / V ) + z}{( μ / V ) + 1} & ( 1 ) \\ {V}^{′} = \frac{( {μ}^{2} / V ) + z}{{( ( μ / V ) + 1 )}^{2}} & ( 2 )\end{matrix}$$

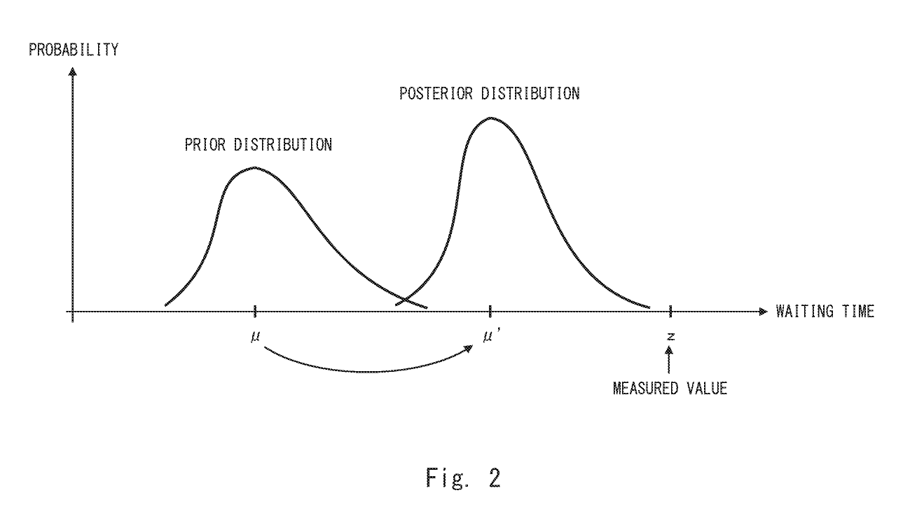

Further, the transition from the prior distribution to the posterior distribution of the probability when the gamma distribution Bayesian statistics are used is expressed as shown in FIG. 2.

The waiting mode determination circuit 21 selects, based on the expected value μ′ of the new waiting time calculated by the operation circuit 20, the waiting state when the apparatus to be controlled 15 is waiting, that is, the type of the waiting mode of the apparatus to be controlled 15. The output of the waiting mode determination circuit 21 is supplied to the waiting mode control circuit 12 as waiting mode information.

In this embodiment, a case in which there are three types of waiting modes: a shallow standby mode, a deep standby mode, and a power off mode, will be described as an example.

In the shallow standby mode, for example, the clock signal is not supplied to the apparatus to be controlled 15 and the power supply voltage having a normal driving capability is supplied to the apparatus to be controlled 15. In the deep standby mode, the clock signal is not supplied to the apparatus to be controlled 15 and only the power supply voltage having a driving capability lower than normal is supplied. In the power off mode, neither the clock signal nor the power supply voltage is supplied to the apparatus to be controlled 15.

Referring back to FIG. 9, when the waiting time is short (e.g., time t0 (inclusive) to time t1 (exclusive)), the total energy consumption is minimized when the shallow standby mode is selected. When the waiting time is moderate (e.g., time t1 (inclusive) to time t2 (exclusive)), the total energy consumption is minimized when the deep standby mode is selected. When the waiting time is long (e.g., time t2 or longer), the total energy consumption is minimized when the power off mode is selected.

Accordingly, when the expected value μ′ of the new waiting time is from time t0 (inclusive) to time t1 (exclusive) (when t0≦μ′<t1), the waiting mode determination circuit 21 selects the shallow standby mode as the waiting mode. Further, when the expected value μ′ of the new waiting time is from time t1 (inclusive) to time t2 (exclusive) (when t1≦μ′<t2), the deep standby mode is selected as the waiting mode. Further, when the expected value μ′ of the new waiting time is equal to or larger than time t2 (when) t2≦μ′), the power off mode is selected as the waiting mode.

The waiting mode control circuit 12 sets the waiting state when the apparatus to be controlled 15 is waiting to a waiting state in accordance with the expected value μ′ of the new waiting time. More specifically upon receiving the WIT instruction issued by the CPU 151, the waiting mode control circuit 12 changes the mode of the apparatus to be controlled 15 from the normal operation mode to the waiting mode that has been selected by the waiting mode determination circuit 21.

When the waiting mode information output from the waiting mode determination circuit 21 indicates the shallow standby mode, for example, the waiting mode control circuit 12 changes the mode of the apparatus to be controlled 15 from the normal operation mode to the shallow standby ode after receiving the WIT instruction. More specifically, the waiting mode control circuit 12 stops supply of the clock signal to the apparatus to be controlled 15 and keeps supply of the power supply voltage having the normal driving capability.

On the other hand, when the waiting mode information output on the waiting mode determination circuit 21 indicates the deep standby mode, for example, the waiting mode control circuit 12 changes the mode of the apparatus to be controlled 15 from the normal operation mode to the deep standby mode after receiving the WIT instruction. More specifically, the waiting mode control circuit 12 stops supply of the clock signal to the apparatus to be controlled 15 and supplies the power supply voltage having a driving capability lower than normal.

Further, when the waiting mode information output from the waiting mode determination circuit 21 indicates the power off mode, for example, the waiting mode control circuit 12 changes the mode of the apparatus to be controlled 15 from the normal operation mode to the power off mode after receiving the WIT instruction. More specifically, the waiting mode control circuit 12 stops supply of the clock signal to the apparatus to be controlled 15 and also stops supply of the power supply voltage.

When the interruption signal receiving circuit 11 receives the interruption signal (external interruption signal) supplied from an outside of the semiconductor system 1, the interruption signal receiving circuit 11 transmits the interruption signal (external interruption signal) to the waiting mode control circuit 12.

When the waiting mode control circuit 12 receives the interruption signal from the interruption signal receiving circuit 11, the waiting mode control circuit 12 changes the mode of the apparatus to be controlled 15 from the waiting mode to the normal operation mode. Specifically, the waiting mode control circuit 12 causes the power supply circuit 13 to start supplying the power supply voltage and causes the clock generation circuit 14 to start supplying the clock signal. Further, the waiting mode control circuit. 12 outputs a CPU startup signal to the CPU 151. The CPU 151 is thus able to return to a normal instruction processing operation.

### (Operation of Setting Waiting Mode by Semiconductor System 1)

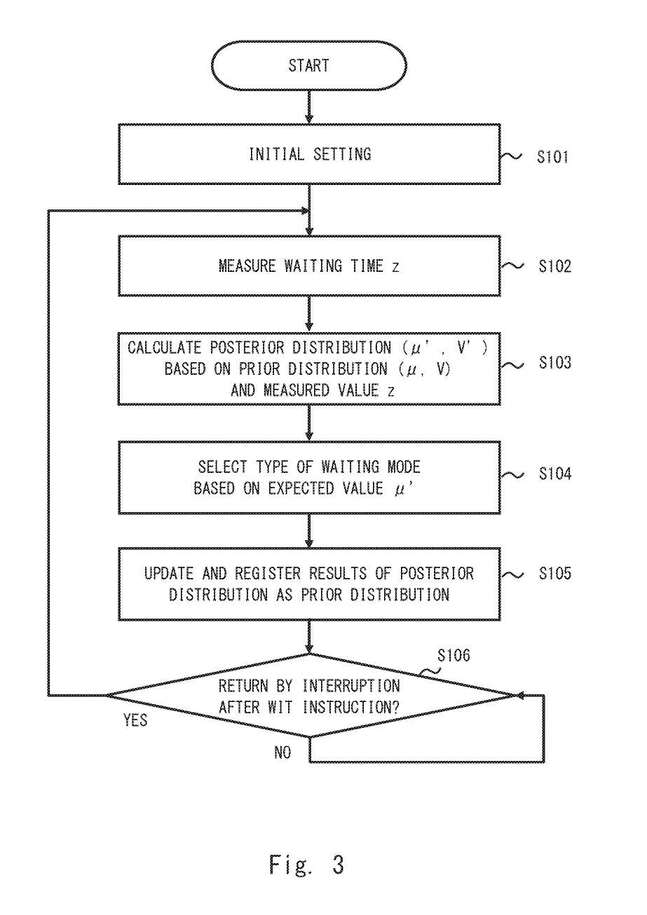

With reference next to FIG. 3, an operation of setting the waiting mode by the semiconductor system 1 will be described.

FIG. 3 is a flowchart, showing the operation of setting the waiting mode by the semiconductor system 1.

First, before the mode of the apparatus to be controlled 15 is changed to the waiting mode, an initial setting is carried out (Step S101). Specifically, the expected value μ and the variance V determined based on the past measurement results or the like are stored in the prior distribution value storage unit 18 as initial values. An initial value 0 is stored, for example, in the measured value storage unit 19. In this case, the operation circuit 20 directly outputs the expected value μ and the variance V as the expected value μ′ and the variance V′.

In this example, the initial value of the expected value μ′ indicates a value within a range from time t0 to t1. Accordingly, the waiting mode determination circuit 21 selects the shallow standby mode as the waiting mode.

After that, when execution of the predetermined program is completed in the normal operation mode, the CPU 151 issues the WIT instruction to change the mode from the normal operation mode to the waiting mode.

Upon receiving the WIT instruction, the waiting mode control circuit 12 changes the mode of the apparatus to be controlled 15 from the normal operation mode to the waiting mode that has been selected by the waiting mode determination circuit 21. In this example, the waiting mode control circuit 12 changes the mode of the apparatus to be controlled 15 from the normal operation mode to the shallow standby mode. Accordingly, the supply of the clock signal to the apparatus to be controlled 15 is stopped.

Then, upon receiving the external interruption signal, the waiting mode control circuit 12 changes the mode of the apparatus to be controlled 15 from the waiting mode (in this example, shallow standby mode) to the normal operation mode. Specifically, the waiting mode control circuit 12 causes the clock generation circuit 14 to start supplying the clock signal. Further, the waiting mode control circuit 12 outputs the CPU startup signal to the CPU 151. The CPU 151 is therefore able to return to the normal instruction processing operation.

Now, the period from the time when the WIT instruction is issued until the time when the interruption signal is supplied from an outside, that is, the waiting time of the apparatus to be controlled 15, is measured using the RTC 16 and the register 17 (Step S102). The measured value z of the waiting time is stored in the measured value storage unit 19.

After that, the operation circuit 20 calculates the expected value μ′ and the variance V′ (posterior distribution) of the new waiting time by substituting the measured value z of the waiting time stored in the measured value storage unit 19 and the expected value μ and the variance V (prior distribution) of the waiting time stored in the prior distribution value storage unit 18 into an expression of gamma distribution Bayesian statistics (Step S103).

The expected value μ′ of the new waiting time indicates, for example, a value in a range from time t1 to t2. Accordingly, the waiting mode determination circuit 21 selects the deep standby mode as the waiting mode (Step S104).

The expected value μ′ and the variance V′, which are posterior distribution, are stored (overwritten) in the measured value storage unit 19 as the expected value μ and the variance V, which are prior distribution (Step S105).

When the apparatus to be controlled 15 further issues the next WIT instruction and then returns by an interruption (YES in Step S106), the operations of Steps S102 to S105 are repeated. On the other hand, when the apparatus to be controlled 15 does not return by an interruption after it has issued the WIT instruction (NO in Step S106), the state of the posterior distribution in Step S105 kept.

That is, when execution of another program is completed in the normal operation mode, the CPU 151 issues the WIT instruction to change the mode from the normal operation mode to the waiting mode.

When the waiting mode control circuit 12 receives the WIT instruction, the waiting mode control circuit 12 changes the mode of the apparatus to be controlled 15 from the normal operation mode to the waiting mode selected by the waiting mode determination circuit 21. In this example, the waiting mode control circuit 12 changes the mode of the apparatus to be controlled 15 from the normal operation mode to the deep standby mode. Accordingly, the supply of the clock signal to the apparatus to be controlled 15 is stopped and the driving capability of the power supply voltage supplied to the apparatus to be controlled 15 becomes low.

After that, when the waiting mode control circuit 12 receives the external interruption signal, the waiting mode control circuit 12 changes the mode of the apparatus to be controlled 15 from the waiting mode (in this example, the deep standby mode) to the normal operation mode. Specifically, the waiting mode control circuit 12 causes the power supply circuit 13 to start supplying the power supply voltage and pauses the clock generation circuit 14 to start supplying the clock signal. Further, the waiting mode control circuit 12 outputs the CPU startup signal to the CPU 151. The CPU 151 is therefore able to return to the normal instruction processing operation.

The time from the issuance of the WIT instruction to the supply of the interruption signal from an outside, that is, the measured value z of the waiting time of the apparatus to be controlled 15, is highly likely to exhibit a value within a range from time t1 to t2 according to the Bayesian statistics. Accordingly, by selecting the deep standby mode as the waiting mode, the total energy consumption can be minimized. That is, it is possible to efficiently reduce the power consumption.

In this way, the semiconductor system 1 according to this embodiment calculates the new expected value μ′ based on the measured value z of the waiting time of the apparatus to be controlled that varies depending on the timing when the interruption signal is generated and the expected value μ to thereby set the waiting state when the apparatus to be controlled is waiting to the waiting state in accordance with the expected value μ′. Accordingly, even in a case in which the waiting time of the apparatus to be controlled varies according to the timing when the interruption signal is generated, the semiconductor system 1 is able to predict the waiting time and control the apparatus to be controlled to the optimal waiting state, whereby it is possible to efficiently reduce the power consumption.

While the case in which there are three types of waiting modes has been described in this embodiment, the present invention is not limited to this case. The number of types of waiting modes may be any number that is equal to or larger than two. Further, the waiting state in each of the waiting modes may be a desired state in which it is possible not only to limit the supply of the clock signal and the power supply voltage but also to reduce the power consumption.

Further, while the case in which the expression of gamma distribution Bayesian statistics is used has been described as an example in this embodiment, the present invention is not limited to this case. A desired expression of distribution Bayesian statistics from which the posterior distribution (μ′, V′) can be calculated based on the prior distribution (μ, V) the measured value z may be used.

### (Modified Example of Semiconductor System)

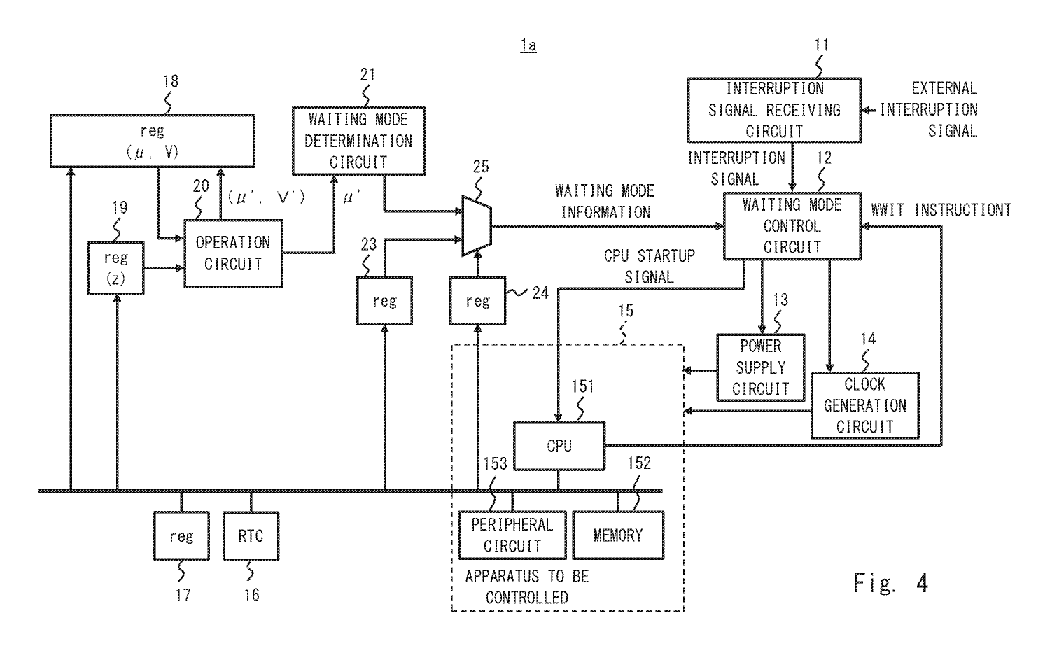

FIG. 4 is a diagram showing a modified example of the semiconductor system 1 as a semiconductor system 1a.

The semiconductor system 1a is able to selectively use a configuration of the semiconductor system 1 in which the type of the waiting mode is automatically switched and a configuration in which the type of the waiting mode is fixed.

As shown in semiconductor system 1a further includes, besides the configurations of the semiconductor system 1, a waiting mode information storage unit 23, a switching information storage unit 24, and a selector 25.

The waiting mode information storage unit 23 stores, for example, a predetermined type of waiting mode information determined based on the past measurement results or the like.

The switching information storage unit 24 stores information indicating whether to automatically switch or the type of the waiting mode. This information can be changed as appropriate by the CPU 151 or the like.

The selector 25 selects, based on the information stored in the switching information storage unit 24, one of the waiting mode information selected by the waiting mode determination circuit 21 and a predetermined type of waiting mode information stored in the waiting mode information storage unit 23 and outputs the selected information. The waiting mode information output from the selector 25 is supplied to the waiting mode control circuit 12.

Since the other configurations and the operations of the semiconductor system 1a are similar to those in the semiconductor system 1, the descriptions thereof will be omitted.

The semiconductor system 1a is able to fix the type of the waiting mode when the waiting time at the time of waiting is known in advance and automatically switch the type of the waiting mode for the operation when the waiting time at the time of waiting is not known in advance.

### Second Embodiment

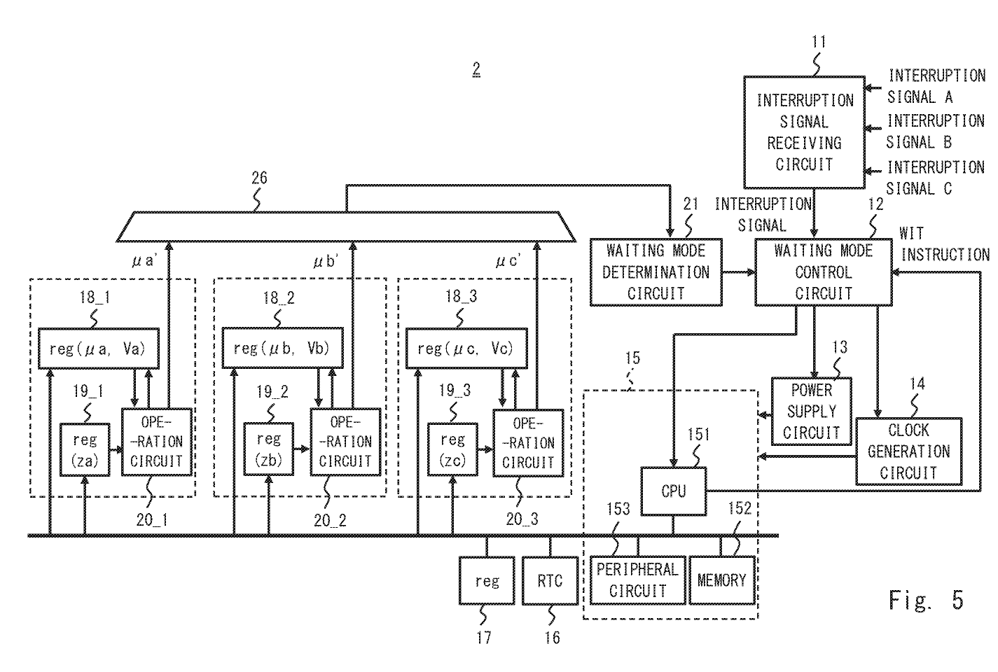

FIG. 5 is a block diagram showing a configuration example of a semiconductor system 2 according to a second embodiment. In the semiconductor system 1, a single operation circuit is provided. On the other hand, in the semiconductor system 2, a plurality of operation circuits are provided to calculate the expected value and the variance of the waiting time separately depending on the type of the interruption signal.

As shown in FIG. 5, the semiconductor system 2 includes operation circuits 20_1 to 20_3, prior distribution value storage units 18_1 to 18_3, and measured value storage units 19_1 to 19_3 in place of the operation circuit 20, the prior distribution value storage unit 18, and the measured value storage unit 19 included in the semiconductor system 1, and further includes a selector 26.

The interruption signal receiving circuit 11 receives, for example, three kinds of interruption signals A to C as an external interruption signal.

The measured value storage unit 19_1 stores a measured value za of the waiting time when the waiting mode is released by the interruption signal A. The prior distribution value storage unit 18_1 stores an expected value μa and a variance Va of the waiting time when the waiting mode is released by the interruption signal A. The operation circuit 20_1 calculates an expected value μa′ and a variance Va′ of the waiting time based on the measured value za of the waiting time and the expected value μa and the variance Va of the waiting time.

The measured value storage unit 19_2 stores a measured value zb of the waiting time when the waiting mode is released by the interruption signal B. The prior distribution value storage unit 18_2 stores an expected value μb and a variance Vb of the waiting time when the waiting mode is released by the interruption signal B. The operation circuit 20_2 calculates an expected value μb′ and a variance Vb′ of the waiting time based on the measured value zb of the waiting time and the expected value μb and the variance Vb of the waiting time.

The measured value storage unit 19_3 stores a measured value zc of the waiting time when the waiting mode is released by the interruption signal C. The prior distribution value storage unit 18_3 stores an expected value μc and a variance Vc of the waiting time when the waiting mode is released by the interruption signal C. The operation circuit 20_3 calculates an expected value μc′ and a variance VC′ of the waiting time based on the measured value zc of the waiting time and the expected value μc and the variance Vc of the wafting time.

The selector 26 selects one of the expected values μa′, μb′, and μc′ of the new wafting time respectively output from the operation circuits 20_1 to 20_3 and outputs the selected value. This output is supplied to the waiting mode determination circuit 21.

The selector 26 selects, for example, the expected value of the waiting time corresponding to the interruption signal that is highly likely to release the waiting mode, specifically, the expected value indicating the minimum value, from the expected values μa′, μb′, and μc′ of the new waiting time, and outputs the selected value.

Since the other configurations of the semiconductor system 2 are similar to those of the semiconductor system 1, the descriptions thereof will be omitted.

### (Operation of Setting Waiting Mode By Semiconductor System 2)

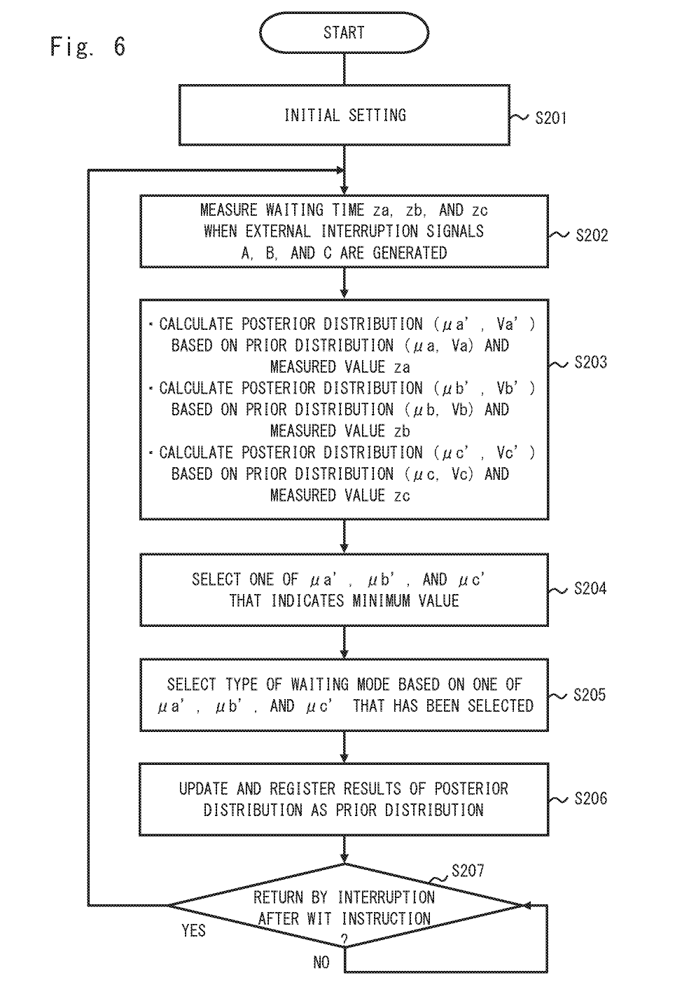

With reference next to FIG. 6, an operation of setting the waiting mode by the semiconductor system 2 will be described.

FIG. 6 is a flowchart showing an operation of setting the waiting mode by the semiconductor system 2.

First, an initial setting is carried out before the mode of the apparatus to be controlled 15 is changed to the waiting mode (Step S201).

Specifically, the prior distribution value storage unit 18_1 stores the expected value μa and the variance Va that have been determined based on the past measurement results or the like as an initial value. The prior distribution value storage unit 18_2 stores the expected value μb and the variance Vb that have been determined based on the past measurement results or the like as an initial value. The prior distribution value storage unit 18_3 stores the expected value μc and the variance Vc that have been determined based on the past measurement results or the like as an initial value. The measured value storage units 19_1 to 19_3 store, for example, an initial value 0. In this case, the operation circuit 20_1 directly outputs the expected value μa and the variance a as the expected value μa′ and the variance Va′. The operation circuit 20_2 directly outputs the expected value μb and the variance Vb as the expected value μb′ and the variance Vb′. The operation circuit 20_3 directly outputs the expected value μc and the variance Vc as the expected value μc′ and the variance Vc′.

In this example, the initial values of the expected values μa′, μb′, and μc′ all indicate values within a range of time t2 or more. The selector 26 selects the expected value μa′ from the expected values μa′ , and μc′ and outputs the expected value μa′. Therefore, the waiting mode determination circuit 21 selects the power off mode as the waiting mode.

After that, basically, similar to the case in the semiconductor system 1, measurement of the waiting time performed (Step S202). The measured values za to zc of the waiting time when the waiting mode is released by the interruption signals A to C are respectively stored in the measured value storage units 19_1 to 19_3.

Then the operation circuit 20_1 calculates the expected value μa′ and the variance Va′ of the new waiting time by substituting the measured value za of the waiting time and the expected value μa and the variance Va of the waiting time into the expression of gamma distribution Bayesian statistics (Step S203). The operation circuit 20_2 calculates the expected value μb′ and the variance Vb′ of the new waiting time by substituting the measured value zb of the waiting time and the expected value μb and the variance Vb of the waiting time into the expression of gamma distribution Bayesian statistics (Step S203). The operation circuit 20_3 calculates the expected value μc′ and the variance Vc′ of the new waiting time by substituting the measured value zc of the waiting time and the expected value μc and the variance Vc of the waiting time into the expression of gamma distribution Bayesian statistics (Step S203).

In this example, the expected value μb′ of the new waiting time indicates a value within a range from time t1 to t2. The expected values μa′ and μc′ of the new waiting time continuously indicate values within a range time t2 or more, which are initial values.

Therefore, the selector 26 selects the expected value μb′ that indicates the minimum value among the expected values μa′, μb′, an μc′ and outputs the selected value (Step S204). Therefore, the waiting mode determination circuit 21 selects the deep standby mode as the waiting mode (Step S205).

The expected value μa′ and the variance Va′ are stored (overwritten) in the measured value storage unit 19_1 as the expected value μa and the variance Va (Step S206). The expected value μb′ and the variance Vb′ are stored (overwritten) in the measured value storage unit 19_2 as the expected value μb and the variance Vb (Step S206). The expected value μc′ and the variance Vc′ are stored (overwritten) in the measured value storage unit 19_3 as the expected value μc and the variance Vc (Step S206).

When the apparatus to be controlled 15 further issues the next WIT instruction and then returns by an interruption (YES in Step S207), the operations of Steps S202 to S206 are repeated. On the other hand, when the apparatus to be controlled 15 does not return by an interruption after it has issued the WIT instruction (NO in Step S207), the state of the posterior distribution in Step S206 is kept.

As stated above, the semiconductor system 2 according to this embodiment is able to obtain effects similar to those when the semiconductor system 1 is used. Further, the semiconductor system 2 according to this embodiment able to predict the waiting time more accurately by calculating the expected value of the waiting time separately depending on the type of the interruption signal, whereby it is possible to reduce the power consumption more efficiently.

While the case in which the expected value of the waiting time is calculated separately for each of the three types of interruption signals has been described as an example, the present invention is not limited to this example. It is sufficient that a configuration in which the expected value of the waiting time is calculated separately for two or more types of interruption signals is employed. It is necessary, however, to provide operation circuits whose number corresponds to the types of the interruption signal.

As described above, the semiconductor systems 1 and 2 according to the first and second embodiments stated above calculate the new expected value based on the measured value of the wait time of the apparatus to be controlled that varies depending on the timing when the interruption signal is generated and the expected value and set the waiting state when the apparatus to be controlled is waiting to the waiting state in accordance with the expected value. Accordingly, the semiconductor systems and 2 are able to predict the waiting time and control the apparatus to be controlled to the optimal waiting state even when waiting time of the apparatus to be controlled varies depending on the timing when the interruption signal is generated, whereby it is possible to efficiently reduce the power consumption.

While the invention made by the present inventors has been specifically described based on the embodiments, it is needless to say that the present invention is not limited to the embodiments stated above and may be changed in various ways without departing from the spirit of he present invention.

For example, in the semiconductor device according to the above embodiments, the conductive type (p-type or n-type) of each of a semiconductor substrate, a semiconductor layer, or a diffusion layer (diffusion region) may be inverted. Therefore, when one conductive type of the n type and the p type is a first conductive type and the other one of the n type and the p type is second conductive type, the first conductive type may be the type and the second conductive type may be the n type and vice versa.

The first and second embodiments can be combined as desirable one of ordinary skill in the art.

While the invention has been described in terms of several embodiments, those skilled in the art will recognize that the invention can be practiced with various modifications within the spirit and scope of the appended claims and the invention is not limited to the examples described above.

Further, the scope of the claims is not limited by the embodiments described above.

Furthermore, it is noted that, Applicant's intent is to encompass equivalents of all claim elements, even if amended later during prosecution.

What is claimed is:

1. A semiconductor device comprising:
an operation unit that calculates an expected value of a new waiting time based on a measured value of a waiting time of an apparatus to be control led that varies depending on a timing when an interruption signal is generated and an expected value of the waiting time, and
a waiting mode control circuit that sets a waiting state when the apparatus to be controlled is waiting to a waiting state in accordance with the expected value of the new waiting time.

2. The semiconductor device according to claim 1, wherein the operation unit calculates the expected value of the new waiting time by substituting the measured value of the waiting time and the expected value of the waiting time into an expression of Bayesian statistics.

3. The semiconductor device according to claim 2, wherein the operation unit calculates the expected value of the new waiting time by substituting the measured value of the waiting time and the expected value of the waiting time into an expression of gamma distribution Bayesian statistics.

4. The semiconductor device according to claim 1, further comprising:
first selector that selects one of the expected value of the new waiting time calculated by the operation unit and an expected value of a predetermined waiting time and outputs the selected value,
wherein the waiting mode control circuit sets the waiting state when the apparatus to be controlled is waiting to a waiting state in accordance with the expected value output from the first selector.

5. The semiconductor device according to claim 1, wherein:
the operation unit comprises:
a first operation circuit that calculates an expected value of a new first waiting time based on a measured value of a first waiting time, which is the waiting time of the apparatus to be controlled that varies depending on a timing when the interruption signal of a first type is generated, and an expected value of the first waiting time; and
a second operation circuit that calculates an expected value of a new second waiting time based on a measured value of a second waiting time which is the waiting time of the apparatus to be control led that varies depending on a timing when the interruption signal of a second type is generated, and an expected value of the second waiting time,
the semiconductor device further comprises a second selector that selects one of the expected value of the new first waiting time calculated by the first operation circuit and the expected value of the new second waiting time calculated by the second operation circuit and outputs the selected value, and
the waiting mode control circuit sets the waiting state when the apparatus to be controlled is waiting to a waiting state in accordance with the expected value output from the second selector.

6. The semiconductor device according to claim 5, wherein:
the first operation circuit calculates the expected value of the new first waiting time by substituting the measured value of the first waiting time and the expected value of the first waiting time into an expression of Bayesian statistics, and
the second operation circuit calculates the expected value of the new second waiting time by substituting the measured value of the second waiting time and the expected value of the second waiting time into an expression of Bayesian statistics.

7. The semiconductor device according to claim 6, wherein:
the first operation circuit calculates the expected value of the new first waiting time by substituting the measured value of the first waiting time and the expected value of the first waiting time into an expression of gamma distribution Bayesian statistics, and
the second operation circuit calculates the expected value of the new second waiting time by substituting the measured value of the second waiting time and the expected value of the second waiting time into the expression of gamma distribution Bayesian statistics.

8. The semiconductor device according to claim 5, wherein the second selector selects an expected value indicating a minimum value from the expected value of the new first waiting time calculated by the first operation circuit and the expected value of the new second waiting time calculated by the second operation circuit and outputs the selected value.

9. A semiconductor system comprising:
the semiconductor device according to claim 1; and
the apparatus to be controlled.

10. The semiconductor system according to claim 9, wherein the semiconductor system is a microcomputer.

11. A control method of a semiconductor device comprising:
measuring a waiting time of an apparatus to be controlled that varies depending on a timing when an interruption signal is generated;
calculating an expected value of a new waiting time based on a measured value of the waiting time and an expected value of the waiting time; and
setting a waiting state when the apparatus to be controlled is waiting to a waiting state in accordance with the expected value of the new waiting time.

12. The control method of the semiconductor device according to claim 11, wherein, in the step of calculating the expected value of the new waiting time, the expected value of the new waiting time is calculated by substituting the measured value of the waiting time and the expected value of the waiting time into an expression of Bayesian statistics.

13. The control method of the semiconductor device according to claim 12, wherein, in the step of calculating the expected value of the new waiting time, the expected value of the new waiting time is calculated by substituting the measured value of the waiting time and the expected value of the waiting time into an expression of gamma distribution Bayesian statistics.

14. The control method of the semiconductor device according to claim 11, comprising:
calculating the expected value of the new waiting time based on the measured value of the waiting time and the expected value of the waiting time; and
selecting one of the expected value of the new time and an expected value of a predetermined waiting time and outputting the selected value,
where n the waiting state when the apparatus to be controlled is waiting is set to a waiting state in accordance with the expected value that has been selected.

15. The control method of the semiconductor device according to claim 11, wherein:
in the step of calculating the expected value of the new waiting time,
an expected value of a new first waiting time is calculated based on a measured value of a first waiting time, which is a waiting time of the apparatus to be controlled that varies depending on a timing when the interruption signal of a first type is generated, and an expected value of the first waiting time, and
an expected value of a new second waiting time is calculated based on a measured value of a second waiting time, which is a waiting time of the apparatus to be controlled that varies depending on a timing when the interruption signal of a second type is generated, and an expected value of the second waiting time, and
in the step of setting the waiting state when the apparatus to be controlled is waiting, a waiting state when the apparatus to be controlled is waiting is set to a waiting state in accordance with an expected value selected from the expected value of the new first waiting time and the expected value of the new second waiting time.

16. The control method of the semi conductor device according to claim 15, wherein, in the step of setting the waiting state when the apparatus to be controlled is waiting, the waiting state when the apparatus to be controlled is waiting is set to a waiting state in accordance with an expected value indicating a minimum value selected from the expected value of the new first waiting time and the expected value of the new second waiting time.
